(19) United States
(12) Patent Application Publication
(10) Pub. No.: US 2012/0102176 A1
(43) Pub. Date: Apr. 26, 2012

(54) EXTRACTING AND MANAGING FONT STYLE ELEMENTS

(75) Inventors: Steve Hsing Lee, San Jose, CA (US); David S. Harned, III, East Dundee, IL (US); Venkat Yetrintala, Wood Dale, IL (US)

(73) Assignee: Monotype Imaging Inc.

(21) Appl. No.: 13/278,713

(22) Filed: Oct. 21, 2011

Related U.S. Application Data
(60) Provisional application No. 61/405,471, filed on Oct. 21, 2010.

(51) Int. Cl. G06F 15/16

(52) U.S. Cl. 709/223

(57) ABSTRACT

A system includes a computing device that includes a memory configured to store instructions. The computing device also includes a processor to execute the instructions to perform a method that includes extracting style information of an element of a network asset by using an identifier of the network asset. The method also includes presenting the extracted style information of the element for managing the network asset.

### CLAIM OF PRIORITY

This application claims priority under 35 USC §119(e) to U.S. Patent Application Ser. No. 61/405,471, filed on Oct. 21, 2010, the entire contents of which are hereby incorporated by reference.

### BACKGROUND

This description relates to extracting and managing style elements associated with various textual fonts.

In the ever-expanding connectivity provided by computer networks such as the Internet, computing devices may present various types of content such as text, graphics, audio, video, etc. Websites, web pages and the like created for individuals, groups, companies, etc. convey information to end users by providing such content. Along with producing, adjusting and managing the provided content, the format in which the content is presented in the websites and web pages may also be defined, adjusted and managed.

### SUMMARY

The systems and techniques described here relate to extracting style elements associated with web assets for managing the asset and other web assets.

In one aspect, a computer-implemented method includes extracting style information of an element of a network asset by using an identifier of the network asset. The method also includes presenting the extracted style information of the element for managing the network asset.

Implementations may include one or more of the following features. The identifier of the network asset may include a cascading style sheet, a uniform resource locator, etc. The element of the network asset may be a sub-element of another element of the network asset. Extracting the style information may be executed at a font service provider. Extracting the style information may be executed at computing device that manages the network asset, a user computing device, etc. Presenting the extracted style information may include allowing adjustments to the extracted style information. Presenting the extracted style information includes presenting the adjusted extracted style information.

In another aspect, a system includes a computing device that includes a memory configured to store instructions. The computing device includes a processor to execute the instructions to perform a method that includes extracting style information of an element of a network asset by using an identifier of the network asset. The method also includes presenting the extracted style information of the element for managing the network asset.

Implementations may include one or more of the following features. The identifier of the network asset may include a cascading style sheet, a uniform resource locator, etc. The element of the network asset may be a sub-element of another element of the network asset. The computing device may be located at a font service provider. The computing device may manage the network asset. The computing device is a user computing device. Presenting the extracted style information may include allowing adjustments to the extracted style information. Presenting the extracted style information includes presenting the adjusted extracted style information.

In another aspect, a computer program product tangibly embodied in an information carrier and includes instructions that when executed by a processor perform a method that includes extracting style information of an element of a network asset by using an identifier of the network asset. The method also includes presenting the extracted style information of the element for managing the network asset.

Implementations may include one or more of the following features. The identifier of the network asset may include a cascading style sheet. The identifier of the network asset may include a uniform resource locator. The element of the network asset may be a sub-element of another element of the network asset. Extracting the style information may be executed at a font service provider. Extracting the style information may be executed at a computing device that manages the network asset. Extracting the style information may be executed at a user computing device. Presenting the extracted style information may include allowing adjustments to the extracted style information. Presenting the extracted style information may include presenting the adjusted extracted style information.

These and other aspects and features and various combinations of them may be expressed as methods, apparatus, systems, means for performing functions, program products, and in other ways.

### DESCRIPTION OF DRAWINGS

FIG. 1 illustrates extracting and managing style elements of web assets.

FIG. 2 is a block diagram of an Internet based system for style element extracting and management.

FIG. 3 is an example flow chart of operations for extracting and managing style elements.

FIG. 4 illustrates components of computing devices.

### DETAILED DESCRIPTION

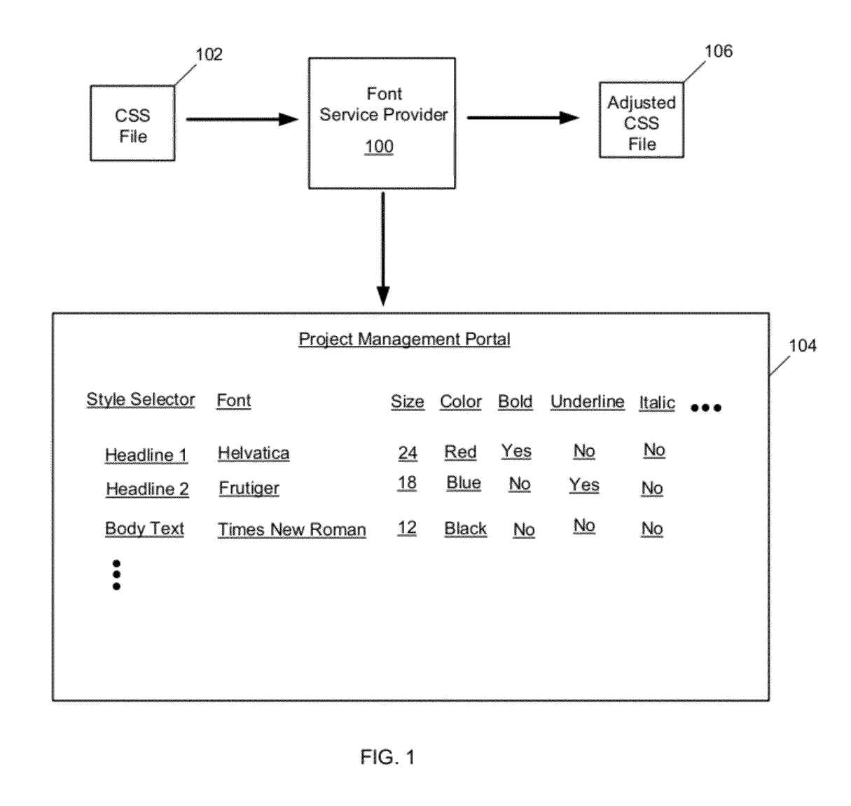

Referring to FIG. 1, stylistic information associated with fonts of web assets are identified, extracted and managed by an Internet based font service provider 100. For example, provided content of web assets such as websites, web pages, etc., the font service provider 100 can extract format information from the content for various applications such as adjusting and manipulating formats, applying the extracted formats to other assets, etc. By extracting such style information, the font service provider 100 can identify font style elements in an automatic manner rather than an individual (e.g., a website designer) laboriously searching through the asset content (e.g., reviewing instructions such as hypertext markup language (HTML) instructions) to identify each style element that describes presentation semantics (e.g., format) of the asset. Various techniques may be implemented to provide a web asset to the font service provider 100 for extracting style element information. For example, a unique identifier associated with the asset (e.g., a Uniform Resource Locator (URL)) or a file or structure that contains a listing of the style elements may be provided to the font service provider 100. In this particular example, a Cascading Style Sheet (CSS) file 102 is provided that defines style elements (e.g., font, font size, font color, etc.) associated with a web asset (e.g., defined by an HTML document). In general the CSS file 102 can be considered as containing instructions that use a collection of keywords to specify the names of various style properties (of one or more structured documents) that may be identified and extracted by the font service provider 100. The instructions of the CSS file 102 can be considered a list of rules that include one or more selectors used to associate elements (e.g., a website headline) and styles (e.g., font, font size, etc). Selectors may apply to all elements of a specific type, or only those elements that match a certain attribute. As such, by identifying style elements such as selectors, properties of the elements may be identified, changed, and applied to other web assets (e.g., for presentation) along with user in other operations.

In this particular example, the CSS file 102 is provided to the font service provider 100, however, other items may be provided for identifying web assets. Along with URLs associated with websites and web pages, files produced by particular applications may be provided to the font service provider 100. For example, documents produced from Microsoft Word or other applications may be provided to the font service provider 100. Once received, the font service provider 100 may execute one or more processes to identify and extract the individual style elements. Identified, the individual elements can be used for various activities such as presenting the elements to a user for adjusting corresponding properties to change the appearance of the web asset. Further, the identified style elements may be incorporated into other web assets such as other web pages and websites, and applications. As illustrated in the figure, a portal 104 may be presented to a user that catalogs each style element (or a portion of the elements) identified from the CSS file 102 along with one or more properties associated with each element. In this example, three elements (e.g., headline 1, headline 2, body text) are represented in the portal along with corresponding properties with particular terms and values (e.g., font, size and color) and Boolean values to indicate if a corresponding property (e.g., bold, underline, italic) is active or inactive.

By extracting and presenting the identified style elements and associated properties in an automatic manner, a user (e.g., website designer) is freed from having to laboriously sift through the individual instructions contained in the CSS file 102 to identify the individual style elements and their corresponding properties. Additionally, by providing the elements and properties through the portal 104 (or other type of user interface), the user can manipulate the properties to change the appearance of the presented contents contained in the CSS file 102. For example, data entry fields, drop-down menus and other interface techniques may be implemented to adjust one or more of the style elements represented in the portal 104. Management of the style elements may also include storing and using the style elements in other projects. For example, the properties associated with one style element (e.g., Headline 1) may be particularly eye-catching in web page advertisements. As such, the style element and associated properties may be stored by the font service provider 100 for use with other files, web pages, websites, etc., separate from the web asset associated with the CSS file 102. Similarly, the portal 104 may perform other operations associated with style elements. Such operations may include adding, replacing and deleting style elements extracted from the CSS file 102. For example, the style element identified as “Headline 2” may be replaced with another style element that incorporates a different font, size, color, etc. From these style elements changes, an adjusted CSS file 106 is shown as being produced by the font service provider 100. Such adjustments may also be stored by the font service provider 100 for later retrieval and application.

Similar to being used to change the style elements associated with web assets (as extracted from CSS files, etc.), portals may be provided to users for creating web assets. For example, along with providing extracted style elements, a portal may be used to create style elements that may be incorporated into particular projects associated with web assets (e.g., websites, web pages, etc.). Referring to the portal 104, additional style elements may be defined along with corresponding selectable properties that may be incorporated into a newly created file (e.g., a CSS file, HTML file, URL, etc.) or a previously produced file.

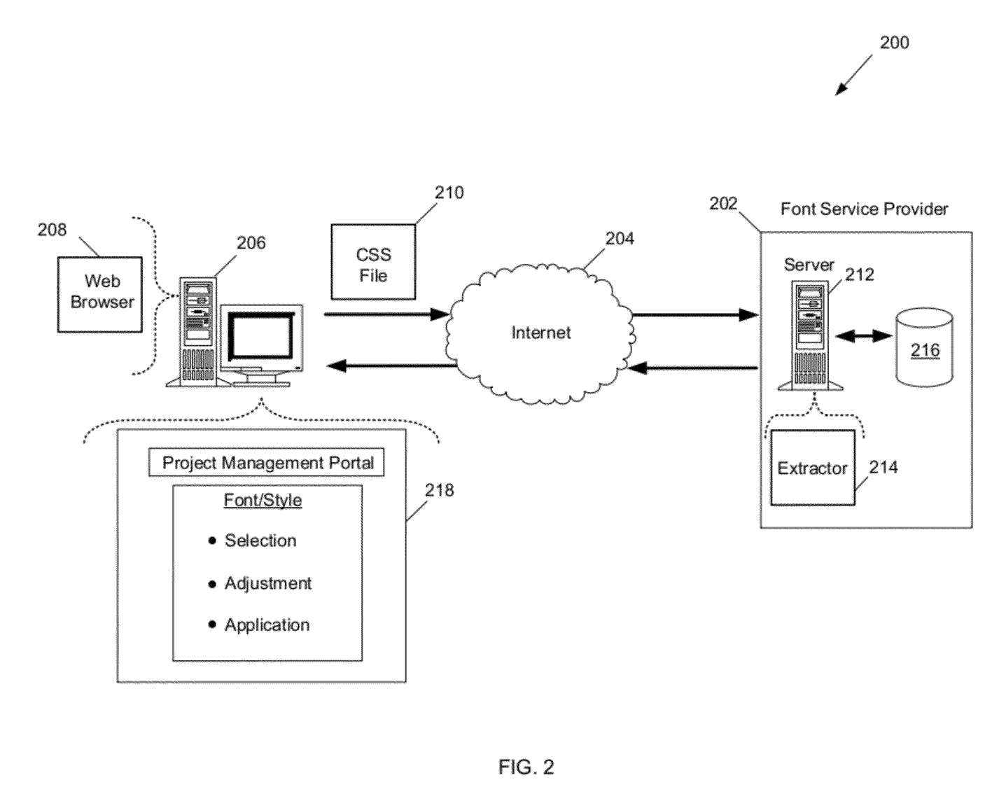

Referring to FIG. 2, a block diagram of an exemplary Internet based system 200 is illustrated in which a user and a font service provider 202 exchange information through the Internet 204 for extracting and managing style elements of web assets (e.g., websites, web pages, etc.). In this arrangement, the user operates a computing device (e.g., a computer system 206) and interacts with a web browser 208 (being executed by the computer system). Through use of the web browser 208 or other types of applications (individually or in combination) various types of web assets (e.g., websites, web pages, etc.) may be created that are accessible by other individuals (e.g., unrestricted, authorized groups, etc.). To create such assets, websites and web based applications may be used through the web browser 208. For example, a website may provide the user with a graphical user interface tailored for creating web assets (e.g., provide menus for defining website titles, control menus, etc.). Once created, the web asset may be partially represented in a CSS file 210 (or by a URL, etc.). By creating assets with such interfaces and corresponding tools, a user (e.g., designer) may be unfamiliar with the individual style elements incorporated into the assets. As such, identifying and adjusting the individual style elements (e.g., from the CSS file 210) may become an extremely time-consuming task. In this arrangement, the CSS file 210 is provided (by way of the Internet 204) to the font service provider 202 for extracting and cataloging the individual style elements used by the web asset. In particular, a server 212 (residing at the font service provider 202) executes an extractor 214 that processes the received CSS file 210 to identify style elements contained in the file. For example, the extractor 214 may parse each instruction included in the CSS file 210 (or an appropriate portion of the file) to identify each style element (e.g., selector) and corresponding properties. The extractor 214 may also initiate or perform other operations, for example, each extracted style element may be stored (e.g., in a storage device 216) and cataloged for later retrieval and use (e.g., for creating or adjusting other web assets).

Various types of content may be extracted from a web asset. For example, content of a web asset may be hierarchical in nature in which elements can be considered as being located at different levels. An element located at a relatively high hierarchy location can be associated with a portion of the web asset that uses a considerable amount of space (e.g., a headline, a complete paragraph of text, etc.) or other measure of the asset. Correspondingly, an element located at lower hierarchy location may use less space on the asset (e.g., one or more words in a paragraph, one or more characters in a word, etc.). As such, in some arrangements, one element (e.g., a word) may be considered a sub-element of another element (e.g., a paragraph) within the hierarchy of the web asset. The extractor 214 may be capable of extracting style element information from one or more of the different levels in the hierarchy of a web asset. For example, style information (e.g., font type, emphasized text, etc.) may be extracted from a CSS file for an element that is a complete paragraph. For an element located lower in the hierarchy of the web asset, the extractor 214 may extract from the CSS file a style element that is a sentence or a word within the paragraph. As such, style information may be extracted at different hierarchical levels of a web asset. For one example, emphasized text within a block quote inside of a paragraph may be extracted from content of a CSS file (e.g., instructions that read “p blockquote em”).

In this particular arrangement, to allow for the management of the style elements of the created web asset (as defined by the CSS file 210), the style element information (or a portion of the information) identified by the extractor 214 is provided to a user (e.g., designer) for review and making adjustments. Passed through the Internet 204, the information is presented in a portal 218, which similar to the portal 104 (shown in FIG. 1), allows the style elements of the web asset to be selected, adjusted (e.g., changed, replaced, deleted, etc.) and applied to the created asset or other web assets. Once changed, information representing the adjusted style elements may be provided to the font service provider 202 for additional processing such as storing and cataloging for other web asset projects.

In the illustrated arrangement, the extractor 214 is executed at the font service provider 202 for extracting style information from the provided CSS file 210. However, in some arrangements operations of the extractor 214 may be executed at another location or at multiple locations (which may or may not include the font service provider 202). For example, a portion of the operations provided by an extractor may be executed at the user site (e.g., on the computer system 206). As such, along with the style information being modified (e.g., by using the portal 218) at this site, the style information may be extracted (e.g., from a CSS file) at the same site by executing the extractor. Operations of the extractor 214 may also be executed at other locations. For example, the functionality of the extractor 214 may be provided to a remotely located computing device (e.g., computer system, server, etc.) that manages one or more web assets (e.g., a web site, webpage, etc.). In one arrangement, the functionality of the extractor 214 may be provided as a computer program (referred to as a web crawler) the browses one or more networks (e.g., the Internet 204) in a methodical manner to investigate assets of the networks (e.g., websites, webpages, etc.). Along with extracting the style information from asset elements, such as a CSS file, additional functionality may be provided. For example, data (e.g., a summary) that represents the extracted information may be provided to a remote location (e.g., the font service provider 202) for processing, e.g., determining if appropriate fonts, text colors, and other types of style features are being used by the asset.

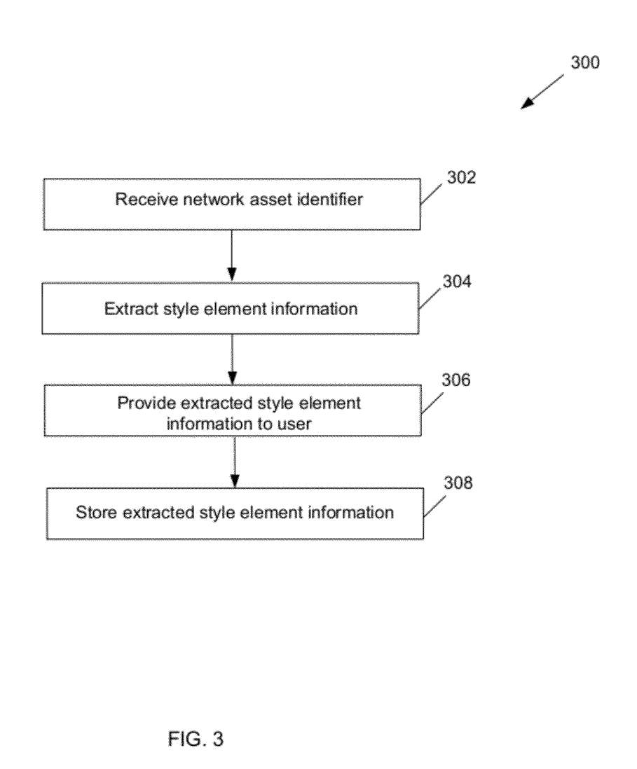

Referring to FIG. 3, a flowchart 300 represents operations provided by a font service provider such as operations provided by a style element extractor (e.g., the extractor 214 shown in FIG. 2). Operations of the style element executor are typically executed by a single computing device (e.g., server 212), however, operations of the executor may be executed by multiple computing devices. Along with being executed at a single site (e.g., at one computer system), operation execution may be distributed among two or more locations.

Operations may include receiving 302 a network asset identifier such as a file containing a CSS, HTML, etc. that defines the asset (or a portion of the asset) such like a web asset (e.g., a website, webpage, etc.). In some arrangements, the network asset may be identified by one or more URLs or by using other similar identification techniques and methodologies. Once received, operations may include extracting 304 style element information (e.g., selectors, properties, etc.) by using the received network asset identifier. Extracted, operations may be executed to process the style element information. For example, operations may include providing 306 the extracted information (or a portion of the information) to a user (e.g., designer of the asset) for adjusting of the style elements (and/or associated properties) to manage the network asset. Operations may also include storing 308 the extracted style element information for later retrieval and use (e.g., for incorporation into one or more other network assets such as web assets like a website, webpage, etc.).

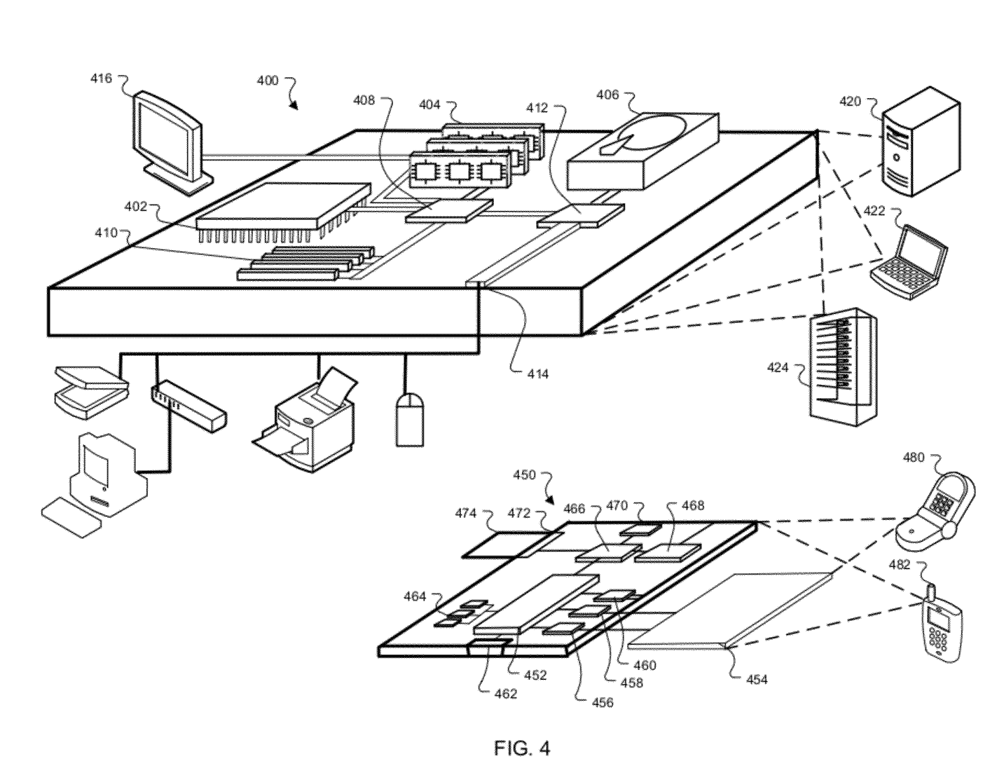

FIG. 4 shows an example of example computer device 400 and example mobile computer device 450 that can be used to implement the techniques described herein. For example, a portion or all of the operations of the extractor 214 may be executed by the computer device 400 (e.g., located at the font service provider 202) and/or by the mobile computer device 450 (operated by an end user). Computing device 400 is intended to represent various forms of digital computers, including, e.g., laptops, desktops, workstations, personal digital assistants, servers, blade servers, mainframes, and other appropriate computers. Computing device 450 is intended to represent various forms of mobile devices, including, e.g., personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 400 includes processor 402, memory 404, storage device 406, high-speed interface 408 connecting to memory 404 and high-speed expansion ports 410, and low speed interface 412 connecting to low speed bus 414 and storage device 406. Each of components 402, 404, 406, 408, 410, and 412, are interconnected using various busses, and can be mounted on a common motherboard or in other manners as appropriate. Processor 402 can process instructions for execution within computing device 400, including instructions stored in memory 404 or on storage device 406 to display graphical data for a GUI on an external input/output device, including, e.g., display 416 coupled to high speed interface 408. In other implementations, multiple processors and/or multiple buses can be used, as appropriate, along with multiple memories and types of memory. Also, multiple computing devices 400 can be connected, with each device providing portions of the necessary operations (e.g., as a server bank, a group of blade servers, or a multi-processor system).

Memory 404 stores data within computing device 400. In one implementation, memory 404 is a volatile memory unit or units. In another implementation, memory 404 is a non-volatile memory unit or units. Memory 404 also can be another form of computer-readable medium, including, e.g., a magnetic or optical disk.

Storage device 406 is capable of providing mass storage for computing device 400. In one implementation, storage device 406 can be or contain a computer-readable medium, including, e.g., a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, including, e.g., those described above. The data carrier is a computer- or machine-readable medium, including, e.g., memory 404, storage device 406, memory on processor 402, and the like.

High-speed controller 408 manages bandwidth-intensive operations for computing device 400, while low speed controller 412 manages lower bandwidth-intensive operations. Such allocation of functions is an example only. In one implementation, high-speed controller 408 is coupled to memory 404, display 416 (e.g., through a graphics processor or accelerator), and to high-speed expansion ports 410, which can accept various expansion cards (not shown). In the implementation, low-speed controller 412 is coupled to storage device 406 and low-speed expansion port 414. The low-speed expansion port, which can include various communication ports (e.g., USB, Bluetooth®, Ethernet, wireless Ethernet), can be coupled to one or more input/output devices, including, e.g., a keyboard, a pointing device, a scanner, or a networking device including, e.g., a switch or router, e.g., through a network adapter.

Computing device 400 can be implemented in a number of different forms, as shown in the figure. For example, it can be implemented as standard server 420, or multiple times in a group of such servers. It also can be implemented as part of rack server system 424. In addition or as an alternative, it can be implemented in a personal computer including, e.g., laptop computer 422. In some examples, components from computing device 400 can be combined with other components in a mobile device (not shown), including, e.g., device 450. Each of such devices can contain one or more of computing device 400, 450, and an entire system can be made up of multiple computing devices 400, 450 communicating with each other.

Computing device 450 includes processor 452, memory 464, an input/output device including, e.g., display 454, communication interface 466, and transceiver 468, among other components. Device 450 also can be provided with a storage device, including, e.g., a microdrive or other device, to provide additional storage. Each of components 450, 452, 464, 454, 466, and 468, are interconnected using various buses, and several of the components can be mounted on a common motherboard or in other manners as appropriate.

Processor 452 can execute instructions within computing device 450, including instructions stored in memory 464. The processor can be implemented as a chipset of chips that include separate and multiple analog and digital processors. The processor can provide, for example, for coordination of the other components of device 450, including, e.g., control of user interfaces, applications run by device 450, and wireless communication by device 450.

Processor 452 can communicate with a user through control interface 458 and display interface 456 coupled to display 454. Display 454 can be, for example, a TFT LCD (Thin-Film-Transistor Liquid Crystal Display) or an OLED (Organic Light Emitting Diode) display, or other appropriate display technology. Display interface 456 can comprise appropriate circuitry for driving display 454 to present graphical and other data to a user. Control interface 458 can receive commands from a user and convert them for submission to processor 452. In addition, external interface 462 can communicate with processor 442, so as to enable near area communication of device 450 with other devices. External interface 462 can provide, for example, for wired communication in some implementations, or for wireless communication in other implementations, and multiple interfaces also can be used.

Memory 464 stores data within computing device 450. Memory 464 can be implemented as one or more of a computer-readable medium or media, a volatile memory unit or units, or a non-volatile memory unit or units. Expansion memory 474 also can be provided and connected to device 450 through expansion interface 472, which can include, for example, a SIMM (Single In Line Memory Module) card interface. Such expansion memory 474 can provide extra storage space for device 450, or also can store applications or other data for device 450. Specifically, expansion memory 474 can include instructions to carry out or supplement the processes described above, and can also include secure data. Thus, for example, expansion memory 474 can be provided as a security module for device 450, and can be programmed with instructions that permit secure use of device 450. In addition, secure applications can be provided through the SIMM cards, along with additional data, including, e.g., placing identifying data on the SIMM card in a non-hackable manner.

The memory can include, for example, flash memory and/or NVRAM memory, as discussed below. In one implementation, a computer program product is tangibly embodied in a data carrier. The computer program product contains instructions that, when executed, perform one or more methods, including, e.g., those described above. The data carrier is a computer- or machine-readable medium, including, e.g., memory 464, expansion memory 474, and/or memory on processor 452 that can be received, for example, over transceiver 468 or external interface 462.

Device 450 can communicate wirelessly through the communication interface 466, which can include digital signal processing circuitry where necessary, or where desired. Communication interface 466 can provide for communications under various modes or protocols, including, e.g., GSM voice calls, SMS, EMS, or MMS messaging, CDMA, TDMA, PDC, WCDMA, CDMA2000, or GPRS, among others. Such communication can occur, for example, through radio-frequency transceiver 468. In addition, short-range communication can occur, including, e.g., using a Bluetooth®, WiFi, or other such transceiver (not shown). In addition, GPS (Global Positioning System) receiver module 470 can provide additional navigation- and location-related wireless data to device 450, which can be used as appropriate by applications running on device 450.

Device 450 also can communicate audibly using audio codec 460, which can receive spoken data from a user and convert it to usable digital data. Audio codec 460 can likewise generate audible sound for a user, including, e.g., through a speaker, e.g., in a handset of device 450. Such sound can include sound from voice telephone calls, can include recorded sound (e.g., voice messages, music files, and the like) and also can include sound generated by applications operating on device 450.

Computing device 450 can be implemented in a number of different forms, as shown in the figure. For example, it can be implemented as cellular telephone 480. It also can be implemented as part of smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include: a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

For situations in which the systems and techniques discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (e.g., to a city, zip code, or state level), so that a particular location of the user cannot be determined.

In some implementations, the engines described herein can be separated, combined or incorporated into a single or combined engine. The engines depicted in the figures are not intended to limit the systems described here to the software architectures shown in the figures.

Processes described herein and variations thereof (referred to as “the processes”) include functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph.

A number of implementations have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other implementations are within the scope of the following claims.

What is claimed is:

1. A computer-implemented method comprising:
extracting style information of an element of a network asset by using an identifier of the network asset; and
presenting the extracted style information of the element for managing the network asset.

2. The computer-implemented method of claim 1, wherein the identifier of the network asset includes a cascading style sheet.

3. The computer-implemented method of claim 1, wherein the identifier of the network asset includes a uniform resource locator.

4. The computer-implemented method of claim 1, wherein the element of the network asset is a sub-element of another element of the network asset.

5. The computer-implemented method of claim 1, wherein extracting the style information is executed at a font service provider.

6. The computer-implemented method of claim 1, wherein extracting the style information is executed at computing device that manages the network asset.

7. The computer-implemented method of claim 1, wherein extracting the style information is executed at a user computing device.

8. The computer-implemented method of claim 1, wherein presenting the extracted style information includes allowing adjustments to the extracted style information.

9. The computer-implemented method of claim 8, wherein presenting the extracted style information includes presenting the adjusted extracted style information.

10. A system comprising:
a computing device comprising:
a memory configured to store instructions; and
a processor to execute the instructions to perform a method comprising:
extracting style information of an element of a network asset by using an identifier of the network asset; and
presenting the extracted style information of the element for managing the network asset.

11. The system of claim 10, wherein the identifier of the network asset includes a cascading style sheet.

12. The system of claim 10, wherein the identifier of the network asset includes a uniform resource locator.

13. The system of claim 10, wherein the element of the network asset is a sub-element of another element of the network asset.

14. The system of claim 10, wherein the computing device is located at a font service provider.

15. The system of claim 10, wherein the computing device manages the network asset.

16. The system of claim 10, wherein the computing device is a user computing device.

17. The system of claim 10, wherein presenting the extracted style information includes allowing adjustments to the extracted style information.

18. The system of claim 17, wherein presenting the extracted style information includes presenting the adjusted extracted style information.

19. A computer program product tangibly embodied in an information carrier and comprising instructions that when executed by a processor perform a method comprising:
extracting style information of an element of a network asset by using an identifier of the network asset; and
presenting the extracted style information of the element for managing the network asset.

20. The computer program product of claim 19, wherein the identifier of the network asset includes a cascading style sheet.

21. The computer program product of claim 19, wherein the identifier of the network asset includes a uniform resource locator.

22. The computer program product of claim 19, wherein the element of the network asset is a sub-element of another element of the network asset.

23. The computer program product of claim 19, wherein extracting the style information is executed at a font service provider.

24. The computer program product of claim 19, wherein extracting the style information is executed at computing device that manages the network asset.

25. The computer program product of claim 19, wherein extracting the style information is executed at a user computing device.

26. The computer program product of claim 19, wherein presenting the extracted style information includes allowing adjustments to the extracted style information.

27. The computer program product of claim 26, wherein presenting the extracted style information includes presenting the adjusted extracted style information.
